(19) United States
(12) Patent Application Publication
(10) Pub. No.: US 2003/0011471 A1
(43) Pub. Date: Jan. 16, 2003

(54) Motion sensing apparatus having a control module and a slave module

(75) Inventor: James R. Goings, Castle Rock, CO (US)

Correspondence Address: TAROLLI, SUNDHEIM, COVELL, TUMMINO & SZABO L.L.P., 111 LEADER BLDG., 526 SUPERIOR AVENUE, CLEVELAND, OH, 44114-1400, US

(73) Assignee: TRW Inc.

(21) Appl. No.: 09/902,411

(22) Filed: Jul. 10, 2001

(51) Int. Cl. B60R 25/10

(52) U.S. Cl. 340/426; 340/539; 340/541

(57) ABSTRACT

An apparatus (12) for detecting motion within an area is provided. The apparatus (12) comprises a control module (28) for controlling operation of the apparatus (12) and for determining whether motion is sensed within the area. The apparatus (12) also comprises at least one slave module (e.g., 30), remotely located from the control module (28), for sensing motion within the area in response to control information from the control module (28) and for providing sensory information to the control module (28). The control module (28) and the at least one slave module (e.g., 30) include components for wireless communication of signals conveying the control information and the sensory information.

### TECHNICAL FIELD

The present invention relates to an apparatus for sensing motion in an area. More particularly, the present invention relates to an apparatus having a control module and at least one slave module for sensing motion within an area.

### BACKGROUND OF THE INVENTION

Intrusion detection within a passenger compartment of a vehicle is known. Typically, if an intrusion is detected, an alarm is actuated. The alarm may include sounding the vehicle's horn, flashing the vehicle's lights, and disabling the vehicle's ignition system to render the vehicle inoperative.

Specifically, an intrusion detection apparatus that utilizes ultrasonic signals and the Doppler principle is known. The apparatus transmits reference signals into the passenger compartment and monitors the frequency of a reflected return signal. Movement within the passenger compartment will cause a frequency shift in the reflected return signal and is know as a Doppler shift. A change in the frequency of the reflected return signal, as compared to the reference signals, may be indicative of an intrusion into the passenger compartment.

It is known to centrally-mount an intrusion detection apparatus on a headliner of a vehicle and monitor the entire passenger compartment of the vehicle from the central location. With a trend in the automotive industry of adding overhead features, a centrally located intrusion detection apparatus may be impractical in many vehicles. Additionally, a centrally located intrusion apparatus requires a high gain so that the entire passenger compartment may be monitored. The high gain increases the likelihood of a false alarm.

An intrusion detection apparatus that does not require central mounting within the vehicle and which does not require a high gain is desirable. One such apparatus includes a control module and remote slave modules that are wired to the control module with communication wires. A separate communication wire attaches each slave module to the control module. Each slave module monitors for motion within a zone of the passenger compartment. By using several slave modules to monitor within zones, a high gain is not required and the likelihood of false alarms is reduced. In addition to monitoring a zone for motion indicative of an intrusion, each slave module also generates and transmits a signal, via the associated communication wire, to the control module. The control module may actuate an alarm if an intrusion is detected within a zone.

### SUMMARY OF THE INVENTION

In accordance with one aspect, the present invention provides an apparatus for detecting motion within an area. The apparatus comprises a control module for controlling operation of the apparatus and for determining whether motion is sensed within the area. The apparatus also comprises at least one slave module, remotely located from the control module, for sensing motion within the area in response to control information from the control module and for providing sensory information to the control module. The control module and the at least one slave module include components for wireless communication of signals conveying the control information and the sensory information.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic plan view of a vehicle including an apparatus constructed in accordance with the present invention;

FIG. 2 is a schematic block diagram of a portion of the apparatus of FIG. 1; and

FIG. 3 is a schematic elevation view of zones adjacent an interior of a passenger side of a vehicle being monitored by the apparatus of the present invention.

### DESCRIPTION OF AN EXAMPLE EMBODIMENT

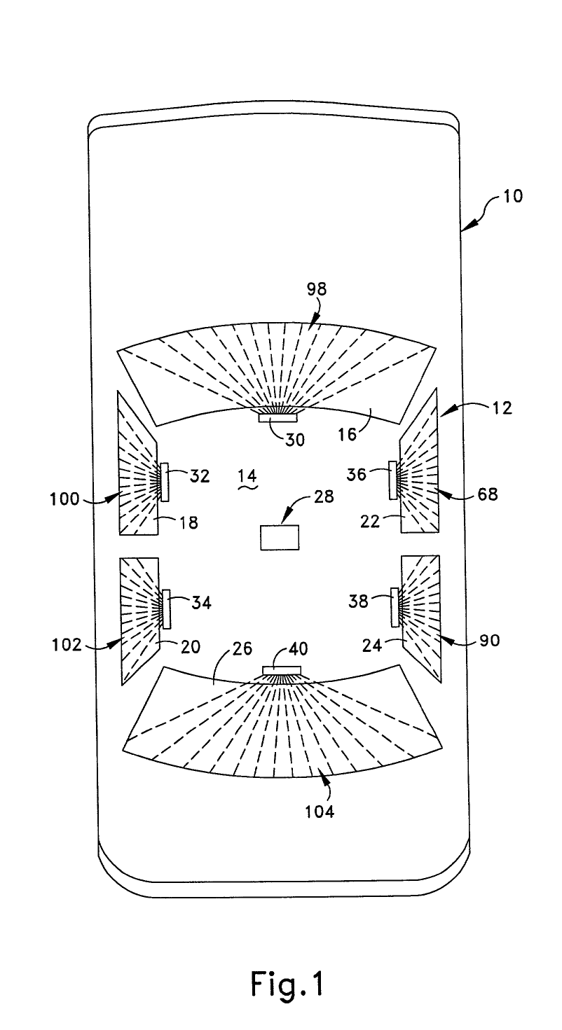

FIG. 1 illustrates a plan view of a vehicle 10. The apparatus 12 of the present invention is installed in the passenger compartment 14 of the vehicle 10. The vehicle 10 illustrated in FIG. 1 includes six windows. The six windows include a windshield 16, front and rear driver side windows 18 and 20, front and rear passenger side windows 22 and 24, and a rear window 26. The six windows 16-26 define the outer periphery of the passenger compartment 14 of the vehicle 10.

The apparatus 12 of the present invention includes a control module 28 and at lease one slave module. Preferably, the apparatus includes six slave modules, one for each window 16-26 of the vehicle 10. Since the vehicle 10 illustrated in FIG. 1 has six windows 16-26, six slave modules are illustrated in FIG. 1. Of course, a different number of slave modules could be used.

The six slave modules includes a first slave module 30 mounted in a location adjacent to and centered above the windshield 16, a second slave module 32 mounted in a location adjacent to and centered above the front driver side window 18, and a third slave module 34 mounted in a location adjacent to and centered above the rear driver side window 20. A fourth slave module 36 is mounted in a location adjacent to and centered above the front passenger side window 22, a fifth slave module 38 is mounted in a location adjacent to and centered above the rear passenger side window 24, and a sixth slave module 40 is mounted in a location adjacent to and centered above the rear window 26.

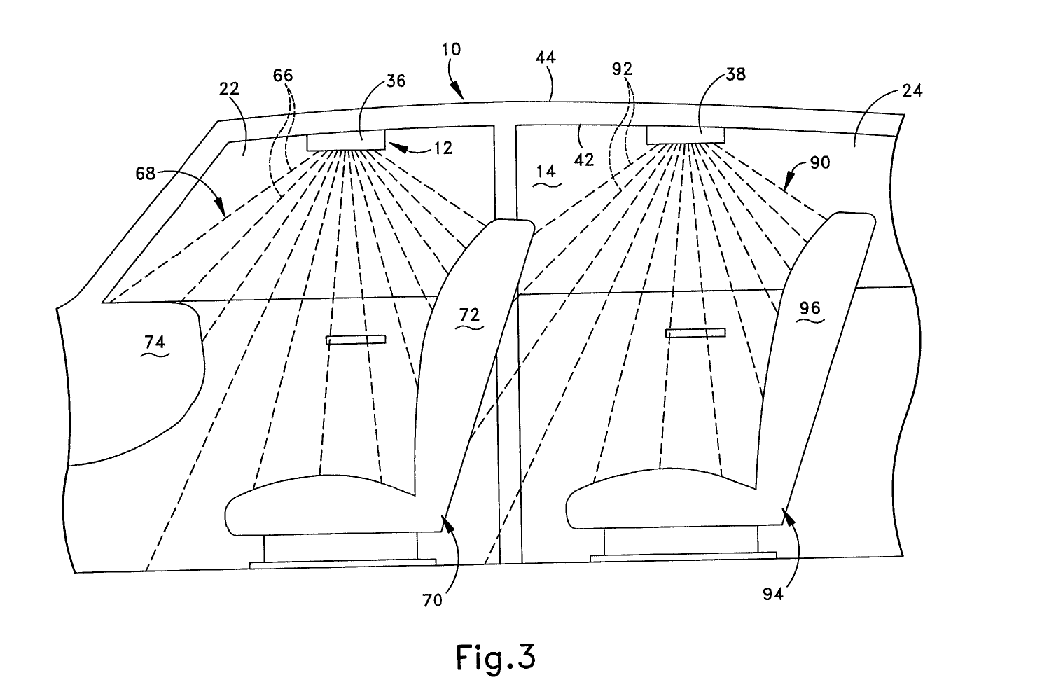

Preferably, the control module 28 is mounted to the headliner or ceiling 42 (FIG. 3) of the passenger compartment 14 of the vehicle 10. The interior of the roof 44 forms the ceiling 42 of the passenger compartment 14. Alternatively, the apparatus 12 may be mounted at some other location within the vehicle passenger compartment 14, such as between front seats of the vehicle 10 or on an upper edge of the windshield 16. A suitable location for the control module 28 is a location that allows transmission of signals between the control module 28 and the slave modules 30-40.

The slave modules 30-40 are also preferably mounted on the ceiling 42 of the passenger compartment 14. As illustrated in FIG. 1, each slave module (e.g., 30) is mounted in a location that is remote from the location of the control module 28. The control module 28 may be physically attached to one of the slave modules (e.g., 30) and be remotely located from the remainder of the slave modules (e.g., 32-40). The control module 28 controls all of the slave modules 30-40. When directed by the control module 28 to operate, each slave module (e.g., 30) monitors an area or zone within the passenger compartment 14 of the vehicle 10.

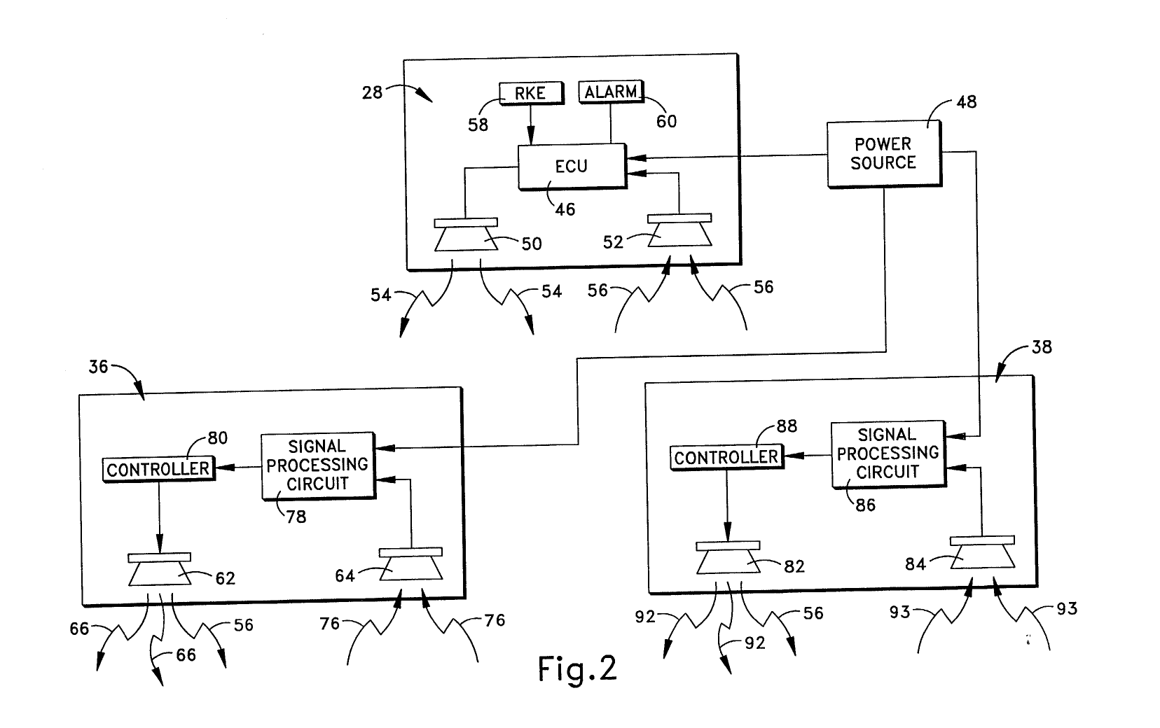

FIG. 2 is a schematic block diagram of a portion of the apparatus 12 of FIG. 1. FIG. 2 illustrates the control module 28 and the fourth and fifth slave modules 36 and 38, respectively. An elevation view of the fourth and fifth slave modules 36 and 38 mounted in the vehicle 10 is shown in FIG. 3.

As shown in FIG. 2, the control module 28 includes an electronic control unit (ECU) 46. Preferably, the ECU 46 is a microcomputer. Alternatively, the ECU 46 may comprise a plurality of discrete circuits, circuit components, and/or an application specific integrated circuit (ASIC) configured to accomplish desired functions. The ECU 46 is electrically coupled to a power source 48. The power source 48 may comprise an energy storage device, such as a battery, or another source of power. Preferably, the power source 48 is the vehicle battery.

The control module 28 also includes a transmitter 50 and a receiver 52. The transmitter 50 is electrically coupled to the ECU 46 and transmits signals 54 containing control information. The control information may include encoded information that is specific to a particular slave module (e.g., 36) or may simultaneously control all of the slave modules 30-40. The control information transmitted by the transmitter 50 may be used to command the slave modules 30-40 to commence operation, to terminate operation, or to perform another function such as transmit a sensory signal.

The receiver 52 of the control module 28 also is electrically coupled to the ECU 46. The receiver 52 receives signals 56 containing sensory information from the slave modules 30-40. Upon receipt of the signals 56, the receiver 52 transfers the sensory information to the ECU 46.

The ECU 46 of the control module 28 includes a switching element (not shown) that is actuatable to enable and disable the apparatus 12. One method of actuating the switching element is by a remote keyless entry (“RKE”) system. FIG. 2 schematically illustrates an RKE receiver 58 that is electrically coupled to the ECU 46 of the control module 28. The RKE system allows the vehicle operator to disable the apparatus 12 before entering the passenger compartment 14 of the vehicle 10 and to enable the apparatus 12 upon exiting the passenger compartment 14.

An alarm 60 is electrically coupled to and is controlled by the ECU 46. Upon detection of an intrusion into the passenger compartment 14 of the vehicle 10, the ECU 46 may actuate the alarm 60. The alarm 60 may include the sounding of the vehicle horn, flashing of the vehicle lights, disabling of the vehicle ignition system, or the transmission of an alarm signal.

The fourth slave module 36, which, with reference to FIG. 3, is mounted adjacent to and above the front passenger side window 22 of the vehicle 10, includes a transmitter 62 and a receiver 64. During operation of the fourth slave module 36, the transmitter 62 transmits continuous wave (“CW”) signals as beams, indicated at 66 in FIGS. 2 and 3. The beams 66 are transmitted throughout the zone 68 (FIG. 3) of the fourth slave module 36. The zone 68 of the fourth slave module 36, as is illustrated in FIG. 3, extends from the back portion 72 of the front passenger seat 70 to the instrument panel 74. The transmitted beams 66 reflect off of objects in the zone 68 of the fourth slave module 36 and reflect throughout the passenger compartment 14. Most of the beams 66, however, reflect within the zone 68 of the fourth slave module 36.

Some of the reflected beams 76 return to the receiver 64 of the fourth slave module 36. As a result, the receiver 64 receives a single wave return signal that is a superposition of all the reflected beams 76 received by the receiver 64 of the fourth slave module 36. Generally, the return signal received by the receiver 64 has the same frequency as the transmitted signals or beams 66, but has a phase and amplitude that varies from the transmitted signals. The phase and amplitude of the return signal are dependent upon the phase and amplitude of the various reflected beams 76 added together at the receiver 64 to form the return signal.

The frequency, amplitude, and phase of the return signal received by the receiver 64 can be expected to remain relatively constant over time if there is no motion within the zone 68 of the fourth slave module 36. However, motion within the zone 68 of the fourth slave module 36 alters the frequency of the reflected beams 76 and thus, the return signal received at the receiver 64. Motion within the zone 68 of the fourth slave module 36 of the vehicle 10 results in a Doppler shift in the frequency of the beams reflected off of the object in motion. A Doppler shift in the frequency of some of the reflected beams 76 alters the frequency, amplitude, and phase of the return signal received by the receiver 64.

The fourth slave module 36 also includes a signal processing circuit 78 and a controller 80. The signal processing circuit 78 may be any known circuit for processing the return signal and providing an output signal that is indicative of the change in frequency, amplitude, and phase of the return signal relative to the signals transmitted by the transmitter 62 of the fourth slave module 36. The output signal from the signal processing circuit 78 is input into the controller 80. The controller 80 runs a known algorithm to determine whether or not the output signal from the signal processing circuit 78 is indicative of an intrusion into the zone 68 of the fourth slave module 36. The controller 80 also generates a signal 56 containing sensory information that is indicative of whether or not an intrusion was determined within the zone 68. The controller 80 sends the signal 56 containing the sensory information to the transmitter 62 where the signal 56 is transmitted into the passenger compartment 14 of the vehicle 10. Preferably, the signal 56 from the fourth slave module 36 is encoded with information indicating that the message was transmitted from the fourth slave module 36.

The fifth slave module 38 also includes a transmitter 82, a receiver 84, a signal processing circuit 86, and a controller 88. The fifth slave module 38 operates in a manner similar to the fourth slave module 36 to monitor for motion in another zone 90 (FIG. 3) of the passenger compartment 14 of the vehicle 10. The transmitter 82 of the fifth slave module 38 also transmits CW signals as beams, indicated at 92 in FIGS. 2 and 3. The beams 92 from the fifth slave module 38 preferably have the same frequency as the beams 92 from the transmitter 82 of the fourth slave module 38. The receiver 84 of the fifth slave module 38 receives reflected beams, indicated at 93 in FIG. 2.

FIG. 3 illustrates the zone 90 that is monitored by the fifth slave module 38. The zone 90 extends from the back portion 72 of the front passenger seat 70, rearward to the back portion 96 of the rear seat 94. The fifth slave module 38 also generates a signal 56 containing sensory information that is indicative of whether or not motion was detected in the zone 90 of the fifth slave module 38. Preferably, the signal 56 from the fifth slave module 38 is encoded with information indicating that the message was transmitted from the fifth slave module 38. The signal 56 from the fifth slave module 38 is also transmitted into the passenger compartment 14 of the vehicle 10.

For simplification of the description, only the fourth and fifth slave modules 36 and 38 have been described in detail. However, each of the first, second, third, and sixth slave modules 30, 32, 34, and 40 includes a transmitter (not shown), a receiver (not shown), a signal processing circuit (not shown), and a controller (not shown) and operates in a manner similar to that of the fourth and fifth slave modules 36 and 38. The first slave module 30 monitors a zone 98 (FIG. 1) adjacent the windshield 16 of the vehicle 10 for motion indicative of an intrusion and generates a signal containing sensory information that is indicative of whether or not an intrusion was detected within the zone 98. The second slave module 32 monitors a zone 100 adjacent the front driver side window 18 of the vehicle 10 for motion indicative of an intrusion and generates a signal containing sensory information that is indicative of whether or not an intrusion was detected in the zone 100. The third slave module 34 monitors a zone 102 adjacent the rear driver side window 20 of the vehicle 10 for motion indicative of an intrusion and generates a signal containing sensory information that is indicative of whether or not an intrusion was detected in the zone 102. The sixth slave module 40 monitors a zone 104 adjacent the rear window 26 of the vehicle 10 for motion indicative of an intrusion and generates a control signal indicating whether or not an intrusion was detected in the zone 104.

Each slave module (e.g., 36) also receives power from a power source 48 (FIG. 2). The power source 48 may be a single battery powering all of the slave modules 30-40, separate batteries for each slave module, or an alternate form of power, such as power transferred by radio frequency to a tank circuit. Preferably, the power source 48 is the vehicle battery.

The receiver 52 of the control module 28 monitors the air within the passenger compartment 14 of the vehicle 10 for signals 56 from the slave modules 30-40. After receiving a signal 56 from a slave module (e.g., 36), the control module 28 determines whether or not motion indicative of an intrusion was sensed within the zone 68, 90, 98, 100, 102, or 104 corresponding to the signal 56. If motion indicative of an intrusion was sensed within a zone 68, 90, 98, 100, 102, or 104 of the passenger compartment 14, the ECU 46 of the control module 28 may trigger the alarm 60. Alternately, the ECU 46 may query the respective slave module (e.g., 36) for an additional indication of an intrusion.

As those skilled in the art will recognize, the signal 56 transmitted by each slave module (e.g., 36) may include the return signal received by the receiver or the output signal from the signal processing circuit of the slave module. In such cases, the control module 28 may run the known algorithm to determine if an intrusion condition exits in the respective zone.

The communication between the control module 28 and the slave modules 30-40 is wireless communication. As such, no communication wires physically connect the control module 28 and the slave modules 30-40. Wireless communication between the control module 28 and the slave modules 30-40 eliminates the need to wire each slave module to the control module during installation of the apparatus 12 in the vehicle 10. Additionally, elimination of the communication wires between the control module 28 and the slave modules 30-40 reduces the overall weight of the apparatus 12.

Although the foregoing description has specifically applied the apparatus 12 of the present invention to detecting an intrusion into the passenger compartment 14 of a vehicle 10, the apparatus 12 may be used to detect an intrusion into any area.

Compared to the known technology, the present invention has several advantages. The present invention eliminates a need for high gain associated with a single point system. The present invention alleviates difficulties in assembly into a vehicle, as communication wires do not connect each slave module to the control module. The present invention can provide weight efficiency, because communication wires would add to the weight of the apparatus. Additionally, the communication wires that would connect slave modules to a control module may be susceptible to radio frequency interference.

From the above description of the invention, those skilled in the art will perceive improvements, changes and modifications. Such improvements, changes and modifications within the skill of the art are intended to be covered by the appended claims.

Having described the invention, I claim the following:

1. An apparatus for detecting motion within an area, the apparatus comprising:
a control module for controlling operation of the apparatus and for determining whether motion is sensed within the area; and
at least one slave module, remotely located from the control module, for sensing motion within the area in response to control information from the control module and for providing sensory information to the control module;
the control module and the at least one slave module including components for wireless communication of signals conveying the control information and the sensory information.

2. The apparatus of claim 1 wherein the components for wireless communication of the control module includes a transmitter and a receiver and wherein the components for wireless communication of the at least one slave module includes a transmitter and a receiver.

3. The apparatus of claim 1 wherein the control information is encoded to control a particular slave module.

4. The apparatus of claim 1 wherein the control information simultaneously controls each slave module.

5. The apparatus of claim 1 wherein the control module includes an electronic control unit, the electronic control unit including a switching element that is actuatable for enabling and disabling the apparatus.

6. The apparatus of claim 5 wherein the switching element is actuated by a remote keyless entry system.

7. The apparatus of claim 5 wherein the electronic control unit is electrically coupled to an alarm and wherein the electronic control unit may actuate the alarm.

8. The apparatus of claim 2 wherein the transmitter of the at least one slave module also transmits motion sensing signals into the area and wherein the receiver of the at least one slave module receives a reflected return signal of the motion sensing signals.

9. The apparatus of claim 8 wherein the at least one slave module also includes a signal processing circuit for processing the reflected return signal and providing an output signal that is indicative of a change in frequency, amplitude, and phase of the reflected return signal relative to the motion sensing signals.

10. The apparatus of claim 9 wherein the at least one slave module further includes a controller for receiving the output signal and running an algorithm for determining if the output signal is indicative of an intrusion into the area.

11. The apparatus of claim 1 wherein the sensory information is indicative of whether or not an intrusion was sensed within the area.

12. The apparatus of claim 1 wherein the signal carrying the sensory information includes encoded information identifying a source of the signal.
